(19) United States
(12) Patent Application Publication
(10) Pub. No.: US 2020/0102516 A1
(43) Pub. Date: Apr. 2, 2020

(54) AVIATION GASOLINE COMPOSITIONS

(71) Applicants: Lyondell Chemical Technology, L.P., Houston, TX (US); VP Racing Fuels, Inc., San Antonio, TX (US)

(72) Inventors: Daniel B. Pourreau, Houston, TX (US); Duane M. Minazzi, JR., San Antonio, TX (US)

(73) Assignees: Lyondell Chemical Technology, L.P., Houston, TX (US); VP Racing Fuels, Inc., San Antonio, TX (US)

(21) Appl. No.: 16/586,111

(22) Filed: Sep. 27, 2019

Related U.S. Application Data
(60) Provisional application No. 62/738,406, filed on Sep. 28, 2018.
(60) Provisional application No. 62/839,389, filed on Apr. 26, 2019.

(51) Int. Cl. C10L 1/30; C10L 1/06; C10L 10/10; C10L 1/18; B64D 37/02; B64D 37/30

(52) U.S. Cl. CPC C10L 1/30; C10L 1/06; C10L 10/10; C10L 1/18; C10L 1/1824; B64D 37/30; C10L 2200/043; C10L 2200/0222; C10L 2200/0236; B64D 37/02

(57) ABSTRACT

An aviation gasoline composition having: from about 70 vol % to about 80 vol % isooctane; from about 5 vol % to about 9 vol % isopentane; from about 10 vol % to about 20 vol % of one or more dialkyl ether; and from about 1 vol % to about 5 vol % of one or more alcohol, from about 0.02 vol % to about 0.07 vol % of one or more octane enhancer such as MMT, and, optionally, one or more additives selected from the group consisting of: antioxidants, anti-icing agents, antistatic additives, corrosion inhibitors, dyes, lubricants, and mixtures thereof, wherein the aviation gasoline has a motor octane number of at least 99.6.

### CROSS-REFERENCE TO RELATED APPLICATIONS

This application claims the benefit of priority to U.S. Provisional Application No. 62/738,406 filed Sep. 28, 2018, and U.S. Provisional Application No. 62/839,389 filed on Apr. 26, 2019, both of which are incorporated here by reference in their entirety.

### TECHNICAL FIELD

This disclosure relates to aviation gasoline formulations. More specifically, this disclosure relates to aviation gasoline formulations having a MON of at least 96.0.

### BACKGROUND

Aviation gasoline (“avgas”) is a fuel used in spark-ignited internal-combustion engines to propel aircraft. Avgas for piston engine aircrafts requires both higher octane and a tighter Reid vapor pressure (“RVP”) range than motor gasolines. Due to the wide range of piston engine technologies in use in the private aviation fleet, the minimum octane requirement for avgas is 100 motor octane number (“MON”), and preferably greater than 102 MON to prevent detonation under the most demanding engine regimes such as turbocharged engines under high loads. The RVP range is tighter than motor gasoline to prevent vapor lock at higher altitude. Avgas components must also be compatible with aircraft components such as engine components, elastomers, gaskets and fuel tank sealants. Lastly, alcohols such as ethanol and methanol are typically not allowed due to their tendency to absorb water, which can lead to both corrosion, gasket swelling, and icing in the fuel lines at altitude. This is unfortunate since methanol and ethanol both have high latent heats of vaporization (“LHV”) and high-octane numbers, both of which have been shown to improve fuel octane. High LHV causes a cooling effect on the fuel during compression which retards detonation and improves octane number.

The range of fuel components that meet the 100 MON octane requirement, proper RVP range, non-corrosivity or hygroscopicity, high LHV, high heat of combustion for fuel efficiency, and compatibility with engine and fuel system materials is extremely limited. Consequently, the private aviation industry continues to use tetraethyl lead (TEL), a toxic substance, to boost the octane of available hydrocarbon fuels such as alkylate and aromatics above 100 MON.

In 2014, the Federal Aviation Administration launched the Piston Aircraft Fuel Initiative (PAFI) program to determine if unleaded 100 MON avgas formulations could be developed that would meet all the requirements for certification by the FAA in all types of available piston engines used in aircraft.

Accordingly, a need exists for an improved avgas formulation that meets all the requirements of 100LL avgas but without the lead, other metallic or toxic octane-boosting additives, or engine modifications of current avgas formulations.

### SUMMARY

Herein disclosed is an aviation gasoline having: from about 55 vol % to about 80 vol % isooctane; and from about 20 vol % to about 45 vol % ethyl-tert-butyl-ether, wherein the aviation gasoline has a MON of at least 99.6.

Also disclosed herein is an aviation gasoline consisting essentially of: from about 55 vol % to about 65 vol % isooctane; from about 25 vol % to about 35 vol % ethyl-tert-butyl-ether (also known as 2-ethoxy-2-methyl-propane); from about 7 vol % to about 13 vol % methyl-tert-butyl-ether (also known as 2-methoxy-2-methylpropane); from about 0.1 vol % to about 2 vol % alcohol; from 0.000 g/gal to about 0.05 g/gal tetraethyl lead; and, optionally, one or more additives selected from the group consisting of: antioxidants, anti-icing agents, antistatic additives, corrosion inhibitors, dyes, and mixtures thereof, and wherein the aviation gasoline has a MON of at least 99.6.

Also disclosed herein is an aviation gasoline consisting of: from about 55 vol % to about 65 vol % isooctane; from about 25 vol % to about 35 vol % ethyl-tert-butyl-ether; from about 7 vol % to about 13 vol % methyl-tert-butyl-ether; from about 0.1 vol % to about 2 vol % alcohol; from 0.000 g/gal to about 0.05 g/gal tetraethyl lead; and, optionally, one or more additives selected from the group consisting of: antioxidants, anti-icing agents, antistatic additives, corrosion inhibitors, dyes, and mixtures thereof, and wherein the aviation gasoline has a MON of at least 99.6.

Also disclosed herein is an aviation gasoline comprising: from about 55 to about 56 vol % isooctane; from about 25 to about 35 vol % ethyl-tert-butyl-ether; from about 5 vol % to about 15 vol % methyl-tert-butyl-ether; from about 0.5 vol % to about 5 vol % methanol; from about 0.3 to about 1.5 vol % ethanol; from about 0.3 to about 1.5 vol % tert-butanol; from 0 to about 5 vol % m-toluidine; and from 0 to about 0.4 g/gal manganese naphthenate, wherein the aviation gasoline has a MON of at least 99.6.

Also disclosed herein is an aviation gasoline comprising: from about 54 to about 64 vol % isooctane; from about 35 to about 45 vol % of one or more dialkyl ethers; and optionally from about 0.1 to about 2 vol % of one or more alcohols, wherein the aviation gasoline has a MON of at least 99.6.

Also disclosed herein is an aviation gasoline comprising: from about 45 vol % to about 80 vol % isooctane; from about 10 vol % to about 45 vol % ethyl-tert-butyl-ether; from about 0 vol % to about 15 vol % methyl-tert-butyl-ether; from about 0 vol % to about 40 vol % of one or more monocyclic aromatic compounds; and from about 0 vol % to about 5 vol % of one or more alcohols, wherein the aviation gasoline has a MON of at least 99.6.

Also disclosed herein is an aviation gasoline comprising: from about 70 vol % to about 80 vol % isooctane (also known as 2,2,4-trimethylpentane); from about 5 vol % to about 9 vol % isopentane (also known as 2-methylbutane); from about 10 vol % to about 20 vol % of one or more dialkyl ether; and from about 1 vol % to about 5 vol % of one or more alcohol, wherein the aviation gasoline has a motor octane number of at least 96.0.

Also disclosed herein is an aviation gasoline consisting essentially of: from about 70 vol % to about 80 vol % isooctane; from about 5 vol % to about 9 vol % isopentane; from about 10 vol % to about 20 vol % of one or more dialkyl ether; from about 1 vol % to about 5 vol % of one or more alcohol; from about 0.02 vol % to about 0.07 vol % of one or more octane enhancer; and optionally, one or more additives selected from the group consisting of: antioxidants, anti-icing agents, anti-static additives, corrosion inhibitors, dyes, lubricants, and mixtures thereof, wherein the aviation gasoline has a motor octane number of at least 99.6.

While multiple embodiments are disclosed, still other embodiments will become apparent to those skilled in the art from the following detailed description. As will be apparent, certain embodiments, as disclosed herein, are capable of modifications in various aspects without departing from the spirit and scope of the claims as presented herein. Accordingly, the detailed description hereinbelow is to be regarded as illustrative in nature and not restrictive.

### DETAILED DESCRIPTION

This disclosure relates to aviation gasoline formulations. Grades of avgas are identified by two numbers associated with the motor octane number (“MON”). The first number indicates the octane rating of the fuel when tested to ‘aviation lean” standards, similar to the “pump rating” associated with automobile gasoline in the US. The second number, however, indicates the octane rating of the fuel when tested to the “aviation rich” standard simulating a supercharged condition with a rich mixture, elevated temperatures, and high manifold pressures. For example, a 91/96 avgas has an octane rating of 91 at the lean setting usually used for cruising and 96 at the rich settings used for take-off and other full-power conditions.

Ethyl-tert-butyl-ether (ETBE) has been used to reduce, but not eliminate, TEL in avgas. ETBE has a MON of 99-102, RVP in the correct range for avgas, low toxicity, and no detrimental effects on engine and fuel tank components, metallurgy, gaskets, sealants, or elastomers. When blended at 30-50 vol % with isooctane, isopentane, and aromatics, ETBE produces unleaded avgas that meets the performance and distillation requirements of 100LL as described in ASTM D910 but the MON is only 98. To boost the MON, a variety of methods or additives, including metallic additives, toxic amines, water-methanol injection, or engine modifications such as spark ignition have been investigated.

For the preparation of the aviation gasoline according to this disclosure, blending may occur in any order as long as the constituents are mixed sufficiently. In order to satisfy other requirements, the aviation gasoline according to the disclosure may contain one or more additives which a person skilled in the art may choose to add from standard additives used in aviation fuel. Such additives include, but are not limited to, antioxidants, anti-icing agents, antistatic additives, corrosion inhibitors, dyes and their mixtures.

In some embodiments of the disclosure, an aviation gasoline may include: from about 55 vol % to about 80 vol % isooctane; and from about 20 vol % to about 45 vol % ethyl-tert-butyl-ether, wherein the aviation gasoline has a MON of at least 99.6. In some embodiments of the disclosure, the aviation gasoline may include from about 56 vol % to about 72 vol % isooctane. In some embodiments of the disclosure, the aviation gasoline may include from about 56 vol % to about 62 vol % isooctane. In some embodiments of the disclosure, the aviation gasoline may include about 59 vol % isooctane. In some embodiments of the disclosure, the aviation gasoline may include from about 25 vol % to about 35 vol % ethyl-tert-butyl-ether. In some embodiments of the disclosure, the aviation gasoline may include from about 28 vol % to about 32 vol % ethyl-tert-butyl-ether. In some embodiments of the disclosure, the aviation gasoline may include about 30 vol % ethyl-tert-butyl-ether.

In some embodiments of the disclosure, the aviation gasoline may additionally comprise from about 5 vol % to about 15 vol % methyl-tert-butyl-ether. In some embodiments of the disclosure, the aviation gasoline may additionally comprise from about 8 vol % to about 12 vol % methyl-tert-butyl-ether. In some embodiments of the disclosure, the aviation gasoline may additionally comprise about 10 vol % methyl-tert-butyl-ether. In some embodiments of the disclosure, the aviation gasoline may additionally comprise from about 0.1 vol % to about 5 vol % alcohol. In some embodiments of the disclosure, the aviation gasoline may additionally comprise from about 0.5 vol % to about 2.5 vol % alcohol. In some embodiments of the disclosure, the aviation gasoline may additionally comprise about 1.0 vol % alcohol. In some embodiments of the disclosure, the alcohol is selected from the group consisting of: methanol and ethanol. In some embodiments of the disclosure, the alcohol is methanol. In some embodiments of the disclosure, the aviation gasoline may additionally comprise one or more additives. In some embodiments of the disclosure, the additive may be selected from the group consisting of antioxidants, anti-icing agents, antistatic additives, corrosion inhibitors, dyes, lubricants, and mixtures thereof In some embodiments of the disclosure, the aviation gasoline may additionally comprise from about 0.001 g/gal to about 0.08 g/gal tetraethyl lead. In some embodiments of the disclosure, the aviation gasoline may additionally comprise from about 0.005 g/gal to about 0.05 g/gal tetraethyl lead. In some embodiments of the disclosure, the aviation gasoline may additionally comprise from about 0.005 g/gal to about 0.03 g/gal tetraethyl lead. In some embodiments of the disclosure, the aviation gasoline may be tetraethyl lead-free. In some embodiments, the aviation gasoline may additionally comprise from about 0.1 vol % to about 5 vol % methanol and from about 0.1 vol % to about 1 vol % water. In some embodiments of the disclosure, the aviation gasoline may additionally comprise from 0 to about 5 vol % of an octane booster. In some embodiments of the disclosure, the aviation gasoline has a MON of at least 100.5. In some embodiments of the disclosure, the aviation gasoline has a MON of at least 101.5. In some embodiments of the disclosure, the aviation gasoline has a MON of at least 102.5. In some embodiments of the disclosure, the octane booster is a toluidine. In some embodiments of the disclosure, the toluidine is m-toluidine. In some embodiments of the disclosure, the octane booster is an aniline-type octane booster. In some embodiments of the disclosure, the aniline-type octane booster is N-methylaniline (NMA). In some embodiments of the disclosure, the octane booster comprises manganese. In some embodiments of the disclosure, the octane booster comprising manganese is present in a concentration of from about 0 to about 0.5 g/gal. In some embodiments of the disclosure, the octane booster is methylcyclopentadienyl manganese tricarbonyl (MMT). In some embodiments of the disclosure, the methylcyclopentadienyl manganese tricarbonyl is present in a concentration of from about 0 to about 0.15 g/gal of aviation gasoline. In some embodiments of the disclosure, the methylcyclopentadienyl manganese tricarbonyl is present in a concentration of from about 0.02 g/gal to about 0.10 g/gal of aviation gasoline. In some embodiments of the disclosure, the octane booster is manganese naphthenate. In some embodiments of the disclosure, the manganese naphthenate is in solution with mineral oil. In some embodiments of the disclosure, the manganese naphthenate is present in a concentration of from about 0 g/gal to about 0.6 g/gal. In some embodiments of the disclosure, the manganese naphthenate is present in a concentration of from about 0.01 g/gal to about 0.4 g/gal.

The present disclosure also provides an aviation gasoline consisting essentially of: from about 55 vol % to about 65 vol % isooctane; from about 25 vol % to about 35 vol % ethyl-tert-butyl-ether; from about 7 vol % to about 13 vol % methyl-tert-butyl-ether; from about 0.1 vol % to about 2 vol % alcohol; from 0.000 g/gal to about 0.05 g/gal tetraethyl lead; and, optionally, one or more additives selected from the group consisting of: antioxidants, anti-icing agents, antistatic additives, corrosion inhibitors, dyes, lubricants, and mixtures thereof, and wherein the aviation gasoline has a MON of at least 99.6. In some embodiments of the disclosure, the aviation gasoline may include from about 57 vol % to about 61 vol % isooctane. In some embodiments of the disclosure, the aviation gasoline may include from about 59 vol % isooctane. In some embodiments of the disclosure, the aviation gasoline may include from about 28 vol % to about 32 vol % ethyl-tert-butyl-ether. In some embodiments of the disclosure, the aviation gasoline may include from about 30 vol % ethyl-tert-butyl-ether. In some embodiments of the disclosure, the aviation gasoline may include from about 8.5 vol % to about 11.5 vol % methyl-tert-butyl-ether. In some embodiments of the disclosure, the aviation gasoline may include from about 10 vol % methyl-tert-butyl-ether. In some embodiments of the disclosure, the aviation gasoline may include from about 0.5 vol % to about 1.5 vol % alcohol. In some embodiments of the disclosure, the aviation gasoline may include from about 1.0 vol % alcohol. In some embodiments of the disclosure, the aviation gasoline may include from 0.000 g/gal to about 0.025 g/gal tetraethyl lead. In some embodiments of the disclosure, the aviation gasoline may include from 0.000 g/gal to about 0.005 g/gal tetraethyl lead. In some embodiments of the disclosure, the aviation gasoline may be tetraethyl lead-free.

In some embodiments of the disclosure, the aviation gasoline may include from 0 to about 5 vol % of an octane booster. In some embodiments of the disclosure, an aviation gasoline has a MON of at least 100.5. In some embodiments of the disclosure, the aviation gasoline has a MON of at least 101.5. In some embodiments of the disclosure, the aviation gasoline has a MON of at least 102.5. In some embodiments of the disclosure, the octane booster is a toluidine. In some embodiments of the disclosure, the toluidine is m-toluidine. In some embodiments of the disclosure, the octane booster is an aniline-type octane booster. In some embodiments of the disclosure, the aniline-type octane booster is N-methylaniline (NMA). In some embodiments of the disclosure, the octane booster comprises manganese. In some embodiments of the disclosure, the octane booster comprising manganese is present in a concentration of from about 0 to about 0.5 g/gal. In some embodiments of the disclosure, the octane booster is methylcyclopentadienyl manganese tricarbonyl (MMT). In some embodiments of the disclosure, the methylcyclopentadienyl manganese tricarbonyl is present in a concentration of from about 0 to about 0.15 g/gal of aviation gasoline. In some embodiments of the disclosure, the methylcyclopentadienyl manganese tricarbonyl is present in a concentration of from about 0.02 g/gal to about 0.10 g/gal of aviation gasoline. In some embodiments of the disclosure, the octane booster is manganese naphthenate. In some embodiments of the disclosure, the manganese naphthenate is in solution with mineral oil. In some embodiments of the disclosure, the manganese naphthenate is present in a concentration of from about 0 g/gal to about 0.6 g/gal. In some embodiments of the disclosure, the manganese naphthenate is present in a concentration of from about 0.01 g/gal to about 0.4 g/gal.

In some embodiments of the disclosure, the alcohol is selected from the group consisting of: methanol and ethanol. In some embodiments of the disclosure, the alcohol is methanol.

The present disclosure also provides an aviation gasoline consisting of: from about 55 vol % to about 65 vol % isooctane; from about 25 vol % to about 35 vol % ethyl-tert-butyl-ether; from about 7 vol % to about 13 vol % methyl-tert-butyl-ether; from about 0.1 vol % to about 2 vol % alcohol; from 0.000 g/gal to about 0.05 g/gal tetraethyl lead; and optionally, one or more additives selected from the group consisting of: antioxidants, anti-icing, agents, antistatic additives, corrosion inhibitors, dyes, lubricants, and mixtures thereof, and wherein the aviation gasoline has a MON of at least 99.6. In some embodiments of the disclosure, the aviation gasoline may include from about 57 vol % to about 61 vol % isooctane. In some embodiments of the disclosure, the aviation gasoline may include from about 59 vol % isooctane. In some embodiments of the disclosure, the aviation gasoline may include from about 28 vol % to about 32 vol % ethyl-tert-butyl-ether. In some embodiments of the disclosure, the aviation gasoline may include from about 30 vol % ethyl-tert-butyl-ether. In some embodiments of the disclosure, the aviation gasoline may include from about 8.5 vol % to about 11.5 vol % methyl-tert-butyl-ether. In some embodiments of the disclosure, the aviation gasoline may include from about 10 vol % methyl-tert-butyl-ether. In some embodiments of the disclosure, the aviation gasoline may include from about 0.5 vol % to about 1.5 vol % alcohol. In some embodiments of the disclosure, the aviation gasoline may include about 1.0 vol % alcohol. In some embodiments of the disclosure, the aviation gasoline may include from 0.000 g/gal to about 0.025 g/gal tetraethyl lead. In some embodiments of the disclosure, the aviation gasoline may include from 0.000 g/gal to about 0.005 g/gal tetraethyl lead. In some embodiments of the disclosure, the aviation gasoline may be tetraethyl lead-free.

In some embodiments of the disclosure, the aviation gasoline may include from 0 to about 5 vol % of an octane booster. In some embodiments of the disclosure, an aviation gasoline has a MON of at least 100.5. In some embodiments of the disclosure, the aviation gasoline has a MON of at least 101.5. In some embodiments of the disclosure, the aviation gasoline has a MON of at least 102.5. In some embodiments of the disclosure, the octane booster is a toluidine. In some embodiments of the disclosure, the toluidine is m-toluidine. In some embodiments of the disclosure, the octane booster is an aniline-type octane booster. In some embodiments of the disclosure, the aniline-type octane booster is N-methylaniline (NMA). In some embodiments of the disclosure, the octane booster comprises manganese. In some embodiments of the disclosure, the octane booster comprising manganese is present in a concentration of from about 0 to about 0.5 g/gal. In some embodiments of the disclosure, the octane booster is methylcyclopentadienyl manganese tricarbonyl (MMT). In some embodiments of the disclosure, the methylcyclopentadienyl manganese tricarbonyl is present in a concentration of from about 0 to about 0.15 g/gal of aviation gasoline. In some embodiments of the disclosure, the methylcyclopentadienyl manganese tricarbonyl is present in a concentration of from about 0.02 g/gal to about 0.10 g/gal of aviation gasoline. In some embodiments of the disclosure, the octane booster is manganese naphthenate. In some embodiments of the disclosure, the manganese naphthenate is in solution with mineral oil. In some embodiments of the disclosure, the manganese naphthenate is present in a concentration of from about 0 g/gal to about 0.6 g/gal. In some embodiments of the disclosure, the manganese naphthenate is present in a concentration of from about 0.01 g/gal to about 0.4 g/gal.

In some embodiments of the disclosure, the at least one alkylate or alkylate blend is isooctane. In some embodiments of the disclosure, the alcohol is selected from the group consisting of: methanol and ethanol. In some embodiments of the disclosure, the alcohol is methanol.

The present disclosure provides an aviation gasoline comprising: from about 70 vol % to about 80 vol % alkylate; from about 5 vol % to about 9 vol % isopentane; from about 10 vol % to about 20 vol % of one or more dialkyl ether; and from about 1 vol % to about 5 vol % of one or more alcohol, wherein the aviation gasoline has a motor octane number of at least 96.0.

In some embodiments of the disclosure, the aviation gasoline comprises about: 70 vol %, 71 vol %, 72 vol %, 73 vol %, 74 vol %, 75 vol %, 76 vol %, 77 vol %, 78 vol %, 79 vol %, 80 vol %, 81 vol %, 82 vol %, 83 vol %, 84 vol %, 85 vol %, 86 vol %, 87 vol %, 88 vol %, 89 vol %, or 90 vol % alkylate. In some embodiments of the disclosure, the aviation gasoline comprises about: 5 vol %, 6 vol %, 7 vol %, 8 vol %, or 9 vol % isopentane. In some embodiments of the disclosure, the aviation gasoline comprises about: 10 vol %, 11 vol %, 12 vol %, 13 vol %, 14 vol %, 15 vol %, 16 vol %, 17 vol %, 18 vol %, 19 vol %, or 20 vol % of one or more dialkyl ether. In some embodiments of the disclosure, the aviation gasoline comprises about: 1 vol %, 2 vol %, 3 vol %, 4 vol % or 5 vol % alcohol. In some embodiments of the disclosure, the aviation gasoline has a MON of 96.0, 96.5, 97.0, 97.5, 98.0, 98.5, 99.0, 99.5, 100.0, 100.5, 101.0, 101.5, 102, or 102.5.

In some embodiments of the disclosure, the alkylate is isooctane. In some embodiments of the disclosure, the one or more dialkyl ether comprises ethyl tert-butyl ether. In some embodiments of the disclosure, the one or more dialkyl ether comprises ethyl tert-butyl ether and methyl tert-butyl ether. In some embodiments of the disclosure, the one or more alcohol comprises methanol. In some embodiments of the disclosure, the one or more alcohol is methanol. In some embodiments of the disclosure, the aviation gasoline additionally comprises from about 0.02 vol % to about 0.07 vol % of one or more octane enhancer. In some embodiments of the disclosure, the aviation gasoline additionally comprises from about 0.025 vol % to about 0.065 vol % of one or more octane enhancer. In some embodiments of the disclosure, the aviation gasoline additionally comprises from about 0.03 vol % to about 0.05 vol % of one or more octane enhancer. In some embodiments of the disclosure, the aviation gasoline additionally comprises from about 0.035 vol % to about 0.06 vol % of one or more octane enhancer. In some embodiments of the disclosure, the aviation gasoline additionally comprises from about 150 μL/L to about 300 μL/L of one or more octane enhancer. In some embodiments of the disclosure, the aviation gasoline additionally comprises from about 50 mg Mn/L to about 90 mg Mn/L of one or more octane enhancer. In some embodiments of the disclosure, the octane enhancer is methylcyclopentadienyl manganese tricarbonyl. In some embodiments of the disclosure, the aviation gasoline additionally comprises one or more additives selected from the group consisting of: antioxidants, anti-icing agents, anti-static additives, corrosion inhibitors, dyes, lubricants, and mixtures thereof. In some embodiments of the disclosure, the aviation gasoline additionally comprises from about 0.001 g/gal to about 0.08 g/gal tetraethyl lead. In some embodiments of the disclosure, the aviation gasoline additionally comprises from about 0.005 g/gal to about 0.075 g/gal tetraethyl lead. In some embodiments of the disclosure, the aviation gasoline additionally comprises from about 0.01 g/gal to about 0.06 g/gal tetraethyl lead. In some embodiments of the disclosure, the aviation gasoline additionally comprises from about 0.03 g/gal to about 0.05 g/gal tetraethyl lead. In some embodiments of the disclosure, the aviation gasoline additionally comprises from about 76 vol % to about 78 vol % isooctane, from about 6 vol % to about 8 vol % isopentane, from about 14 vol % to about 16 vol % of one or more dialkyl ether, from about 0.5 vol % to about 2 vol % of one or more alcohol, and from about 0.02 vol % to about 0.07 vol % of an octane enhancer, wherein the one or more dialkyl ether is ethyl tert-butyl ether, the one or more alcohol is methanol, the octane enhancer is methylcyclopentadienyl manganese tricarbonyl, and the aviation gasoline has a motor octane number of at least 100.5. Some embodiments of the disclosure also includes a fuel tank of a vehicle (e.g., any machine that transports people or cargo, including but not limited to: motor vehicles, railed vehicles, watercraft, and aircraft) at least partially filled by the aviation gasoline. Some embodiments of the disclosure include a storage tank at least partially filled with the aviation gasoline.

The present disclosure also provides an aviation gasoline consisting essentially of: from about 70 vol % to about 80 vol % isooctane; from about 5 vol % to about 9 vol % isopentane; from about 10 vol % to about 20 vol % of one or more dialkyl ether; from about 1 vol % to about 5 vol % of one or more alcohol; from about 0.02 vol % to about 0.07 vol % of one or more octane enhancer; and optionally, one or more additives selected from the group consisting of: antioxidants, anti-icing agents, anti-static additives, corrosion inhibitors, dyes, lubricants, and mixtures thereof, wherein the aviation gasoline has a motor octane number of at least 99.6.

In some embodiments of the disclosure, the one or more dialkyl ether is ethyl tert-butyl ether. In some embodiments of the disclosure, the one or more alcohol is methanol. In some embodiments of the disclosure, the one or more octane enhancer is methylcyclopentadienyl manganese tricarbonyl. In some embodiments of the disclosure, the octane enhancer constitutes about 150 μL/L to about 300 μL/L of the aviation gasoline. In some embodiments of the disclosure, the octane enhancer constitutes about 50 mg Mn/L to about 90 mg Mn/L of the aviation gasoline. In some embodiments of the disclosure, the aviation gasoline consists essentially of about 76 vol % to about 78 vol % isooctane, from about 6 vol % to about 8 vol % isopentane, from about 14 vol % to about 16 vol % of one or more dialkyl ether, from about 0.5 vol % to about 2 vol % of one or more alcohol, and from about 0.02 vol % to about 0.07 vol % of an octane enhancer, wherein the one or more dialkyl ether is ethyl tert-butyl ether, the one or more alcohol is methanol, the octane enhancer is methylcyclopentadienyl manganese tricarbonyl, and aviation gasoline has a motor octane number of at least 100.5. Some embodiments of the disclosure include a vehicle (e.g., any machine that transports people or cargo, including but not limited to: motor vehicles, railed vehicles, watercraft, and aircraft) comprising a fuel tank at least partially filled with the aviation gasoline. Some embodiments of the disclosure include a storage tank at least partially filled with the aviation gasoline.

The following examples merely illustrate the aviation gasolines of this disclosure. Those skilled in the art will recognize many variations that are within the spirit of this disclosure and the scope of the claims.

### EXAMPLE(S)

Example 1. An aviation gasoline of the present disclosure was blended with the following composition: 59 vol % isooctane, 30 vol % ethyl-tert-butyl-ether, 10 vol % methyl-tert-butyl-ether, and 1 vol % methanol. An antioxidant was also added to the blend. The aviation gasoline formulation of Example 1 was analyzed in accordance with ASTM D2699A and ASTM D2700A. Results of these tests are presented in the following Table 1A:

TABLE 1A

| Method | Test | Result |
|---|---|---|
| ASTM D2699A | Observed Barometric | 29.70 |
| | Pressure, in Hg | |
| | Intake Air Temperature, ° F. | 122 |
| | Research Octane Number | 110 |
| | (RON) | |
| ASTM D2700A | Observed Barometric | 29.70 |
| | Pressure, in Hg | |
| | Intake Air Temperature, ° F. | 300 |
| | Motor Octane Number | 100.0 |
| | (MON) | |

A second analysis of Example 1 in accordance with the below identified ASTM test standards yielded the following results as provided in the following Table 1B:

TABLE 1B

| Method | Test | Result | |
|---|---|---|---|
| D 4052-11 | API Gravity @ 60° F. | 65.1 ° | API |
| D 86-12 | Distillation | | |
| | Initial Boiling Point | 58.3° | C. |
| | 05% | 68.2° | C. |
| | 10% | 72.2° | C. |
| | 20% | 77.4° | C. |
| | 30% | 80.6° | C. |
| | 40% | 83.3° | C. |
| | 50% | 86.0° | C. |
| | 60% | 89.3° | C. |
| | 70% | 93.3° | C. |
| | 80% | 97.9° | C. |
| | 90% | 106.7° | C. |
| | 95% | 163.6° | C. |
| | Final Boiling Point (End | 180.2° | C. |
| | Point) | | |
| | Recovery | 98.9 | Vol. % |
| | Residue | 0.9 | Vol. % |
| | Loss | 0.2 | Vol. % |
| | Sum of Evaporation Pt. (10% + | 158.2° | C. |
| | 50%) | | |
| D 5191 (1L) | DVPE (ASTM) @ 37.8° C. | 5.16 | psi |
| D 2699 | Octanes, RON | 112.0 | Rating |
| D 2700 | Octanes, MON | 100.7 | Rating |
| D 2700 | Aviation Lean Rating | 102.9 | Rating |
| D 909 | Performance Number | N/A | |
| D 2622 | Sulfur | 0.0003 | Wt. % |
| D 4815-13 | Oxygenates | | |
| | Methanol | 0.85 | Wt. % |
| | Ethanol | 0.58 | Wt. % |
| | MTBE | 10.32 | Wt. % |
| | ETBE | 30.40 | Wt. % |
| D 130 | Copper Corrosion @ 100° C. | 1a | |
| | (2 hrs) | | |
| D 5059 | Tetraethyl Lead Content | <0.01 | g Pb/l |
| D 2386 | Freezing Point | −74.5° | C. |
| D 2624 | Electrical Conductivity | 1506 | pS/m |
| D 3338 | Net Heat of Combustion | 43.820 | MJ/kg |
| | (sulfur corrected) | | |
| D 873 | Oxidation Stability | | |
| | Potential Gum (5 hr) | 2.4 mg/100 mL | |
| | Lead Precipitate (5 hr) | 0 mg/100 mL | |
| | Aging Characteristic | 5 | Hours |
| D 1094 | Water Reaction in Aviation | | |
| | Fuels | | |
| | Volume Change | 0 | mL |

Unexpectedly, the net heat of combustion of Example 1, 43.820 MJ/kg, exceeds the 100LL specification meaning that the ethers improve combustion, despite their inherent lower energy content, to produce a fuel that behaves similar to a 100% hydrocarbon based fuel.

Example 2. An aviation gasoline of the present disclosure was blended with the following composition: 59 vol % isooctane, 30 vol % ethyl-tert-butyl-ether, 10 vol % methyl-tert-butyl-ether, and 1 vol % methanol. Tetraethyl lead was added in an amount of 0.05 g/gal. An antioxidant was also added to the blend. The aviation gasoline formulation of Example 2 was analyzed in accordance with ASTM D2699A and ASTM D2700A. Results of these tests are presented in the following Table 2A:

TABLE 2A

| Method | Test | Result |
|---|---|---|
| ASTM D2699A | Observed Barometric | 29.70 |
| | Pressure, in Hg | |
| | Intake Air Temperature, ° F. | 122 |
| | Research Octane Number | 110 |
| | (RON) | |
| ASTM D2700A | Observed Barometric | 29.70 |
| | Pressure, in Hg | |
| | Intake Air Temperature, ° F. | 300 |
| | Motor Octane Number | 100.6 |
| | (MON) | |

A second analysis of Example 2 in accordance with the below identified ASTM test standards yielded the following results as provided in the following Table 2B:

TABLE 2B

| Method | Test | Result | |
|---|---|---|---|
| D 4052-11 | API Gravity @ 60° F. | 65.2° | API |
| D 86-12 | Distillation | | |
| | Initial Boiling Point | 59.4° | C. |
| | 05% | 67.5° | C. |
| | 10% | 72.0° | C. |
| | 20% | 77.2° | C. |
| | 30% | 80.6° | C. |
| | 40% | 83.2° | C. |
| | 50% | 85.8° | C. |
| | 60% | 89.0° | C. |
| | 70% | 92.5° | C. |
| | 80% | 97.0° | C. |
| | 90% | 102.6° | C. |
| | 95% | 111.7° | C. |
| | Final Boiling Point (End | 171.4° | C. |
| | Point) | | |
| | Recovery | 97.5 | Vol. % |
| | Residue | 1.3 | Vol. % |
| | Loss | 1.2 | Vol. % |
| | Sum of Evaporation Pt. (10% + | 157.8° | C. |
| | 50%) | | |
| D 5191 (1L) | DVPE (ASTM) @ 37.8° C. | 5.00 | psi |
| D 2699 | Octanes, RON | 111.0 | Rating |
| D 2700 | Octanes, MON | 100.2 | Rating |
| D 2700 | Aviation Lean Rating | 101.6 | Rating |
| D 909 | Performance Number | N/A | |
| D 2622 | Sulfur | 0.0002 | Wt. % |
| D 4815-13 | Oxygenates | | |
| | Methanol | 0.77 | Wt. % |
| | Ethanol | 0.56 | Wt. % |
| | MTBE | 10.00 | Wt. % |
| | ETBE | 29.61 | Wt. % |
| D 130 | Copper Corrosion @ 100°0 C. | 1a | |
| | (2 hrs) | | |
| D 5059 | Tetraethyl Lead Content | 0.02 | g Pb/l |
| D 2386 | Freezing Point | <−78.0° | C. |
| D 2624 | Electrical Conductivity | 1101 | pS/m |
| D 3338 | Net Heat of Combustion | 43.820 | MJ/kg |
| | (sulfur corrected) | | |
| D 873 | Oxidation Stability | | |
| | Potential Gum (5 hr) | 2.6 mg/100 mL | |
| | Lead Precipitate (5 hr) | 0 mg/100 mL | |
| | Aging Characteristic | 5 | hours |
| D 1094 | Water Reaction in Aviation | | |
| | Fuels | | |
| | Volume Change | 0 | ml |

Unexpectedly, the net heat of combustion of Example 2, 43.820 MJ/kg, exceeds the 100LL specification meaning that the ethers improve combustion, despite their inherent lower energy content, to produce a fuel that behaves similar to a 100% hydrocarbon-based fuel.

Example 3. An aviation gasoline of the present disclosure was blended with the following composition: 60 vol % isooctane and 40 vol % ethyl-tert-butyl-ether.

Example 4. An aviation gasoline of the present disclosure was blended with the following composition: 60 vol % isooctane, 30 vol % ethyl-tert-butyl-ether, and 10 vol % methyl-tert-butyl-ether.

Example 5. An aviation gasoline of the present disclosure was blended with the following composition: 59 vol % isooctane, 40 vol % ethyl-tert-butyl-ether, 0.5 vol % methanol, and 0.5 vol % water.

Example 6. An aviation gasoline of the present disclosure was blended with the following composition: 59 vol % isooctane, 30 vol % ethyl-tert-butyl-ether, 10 vol % methyl-tert-butyl-ether, and 1 vol % methanol.

Example 7. An aviation gasoline of the present disclosure was blended with the following composition: 59 vol % isooctane, 40 vol % ethyl-tert-butyl-ether, and 1 vol % methanol.

Example 8. An aviation gasoline of the present disclosure was blended with the following composition: 60 vol % isooctane and 40 vol % ethyl-tert-butyl-ether. Tetraethyl lead was added in an amount of 0.05 g/gal.

Example 9. An aviation gasoline of the present disclosure was blended with the following composition: 70 vol % isooctane and 30 vol % ethyl-tert-butyl-ether. The aviation gasoline formulation of Example 9 was analyzed in accordance with ASTM D2699A and ASTM D2700A yielding a RON of 110.0 and a MON of 102.4.

Example 10. An aviation gasoline of the present disclosure was blended with the following composition: 70 vol % isooctane and 30 vol % ethyl-tert-butyl-ether. Tetraethyl lead was added in an amount of 0.05 g/gal. The aviation gasoline formulation of Example 10 was analyzed in accordance with ASTM D2699A and ASTM D2700A yielding a RON of 110.0 and a MON of 102.9.

Example 11. An aviation gasoline of the present disclosure was blended with the following composition: 69 vol % isooctane, 20 vol % ethyl-tert-butyl-ether, 10 vol % methyl-tert-butyl-ether, and 1 vol % methanol.

Example 12. An aviation gasoline of the present disclosure was blended with the following composition: 70 vol % isooctane and 30 vol % ethyl-tert-butyl-ether.

Example 13. An aviation gasoline of the present disclosure was blended with the following composition: 35 vol % isooctane, 24 vol % mesitylene, 30 vol % ethyl-tert-butyl-ether, 10 vol % methyl-tert-butyl-ether, and 1 vol % methanol. The aviation gasoline formulation of Example 13 was analyzed in accordance with ASTM D2699A and ASTM D2700A yielding a RON of 110.2 and a MON of 100.0. The aviation gasoline formulation of Example 13 had a specific gravity (SG) of 0.7599 and a RVP (ASTM D5191) value of 4.20 psi.

Example 14. An aviation gasoline of the present disclosure was blended with the following composition: 35 vol % isooctane, 24 vol % mesitylene, 40 vol % ethyl-tert-butyl-ether, and 1 vol % methanol. The aviation gasoline formulation of Example 14 was analyzed in accordance with ASTM D2699A and ASTM D2700A yielding a RON of 110.1 and a MON of 99.8. The aviation gasoline formulation of Example 14 had a specific gravity (SG) of 0.7602 and a RVP (ASTM D5191) value of 3.75 psi.

Example 15. An aviation gasoline of the present disclosure was blended with the following composition: 45 vol % isooctane, 24 vol % mesitylene, 30 vol % ethyl-tert-butyl-ether, and 1 vol % methanol. The aviation gasoline formulation of Example 15 was analyzed in accordance with ASTM D2699A and ASTM D2700A yielding a RON of 110.2 and a MON of 99.7. The aviation gasoline formulation of Example 15 had a specific gravity (SG) of 0.7557 and a RVP (ASTM D5191) value of 3.76 psi.

Example 16. An aviation gasoline of the present disclosure was blended with the following composition: 77 vol %, isooctane, 7 vol % isopentane, 15 vol % ethyl-tert-butyl-ether, 1 vol % methanol, and a sufficient quantity of methylcyclopentadienyl manganese tricarbonyl (MMT) to impart a manganese content of about 62 mg Mn/L to the aviation gasoline. The aviation gasoline formulation of Example 16 had a MON of 101.9. The aviation gasoline of Example 16 was analyzed in accordance with ASTM test methods and the results are provided in Table 3.

Example 17. An aviation gasoline of the present disclosure was blended with the following composition: 77 vol %, isooctane, 7 vol % isopentane, 15 vol % ethyl-tert-butyl-ether, 1 vol % methanol, and a sufficient quantity of methylcyclopentadienyl manganese tricarbonyl (MMT) to impart a manganese content of about 86 mg Mn/L to the aviation gasoline. The aviation gasoline formulation of Example 17 had a MON of 102.3. The aviation gasoline of Example 17 was analyzed in accordance with ASTM test methods and the results are provided in Table 4.

Results for Comparative Example 1 (Philips FBO 100LL) and Comparative Example 2 (Dixie Min Spec 100LL) are presented in Tables 5 and 6, respectively.

Example 16 Test Results:

TABLE 3

| | | | | Example | |
|---|---|---|---|---|---|
| | Requirement/ | ASTM | Example | 16 Meets | ASTM Test |
| Specification | Unit | D910 Spec | 16 | D910 Spec | Methods |
| Combustion | | | | | |
| Net Heat of | Minimum | 43.5 | 44.1 | Yes | D4529 or |
| Combustion | (MJ/Kg) | | | | D3338 or |
| | | | | | D4809 |
| | | | | | or D240 |
| Octane Rating | | | | | |
| Knock value, lean | | | | | |
| mixture | | | | | |
| Motor Octane Number | Minimum | 99.6 | 101.9 | Yes | D2700 |
| (MON) | | | | | |
| Aviation lean rating | Minimum | 100.00 | 106.1 | Yes | D2700 |
| Knock value, rich | | | | | |
| mixture | | | | | |
| Performance number | Minimum | 130.00 | >138 | Yes | D909 |
| Requirements for all | | | | | D1266 |
| grades | | | | | |
| Density at 15° C. | Kg/m3 | Report | 702.9 | | D3341 or |
| | | | | | D5059 |
| Distillation | | | | | |
| IBP | ° C. | Report | 48 | | D86 |
| T10 | Maximum, ° C. | 75 | 75 | Yes | D86 |
| T40 | Minimum, ° C. | 75 | 93 | Yes | D86 |
| T50 | Maximum, ° C. | 105 | 95 | Yes | D86 |
| T90 | Maximum, ° C. | 135 | 104 | Yes | D86 |
| End Point | Maximum, ° C. | 170 | 177 | No | D86 |
| Sum of T10 and T50 | Minimum, ° C. | 135 | 171 | Yes | D86 |
| Other Properties | | | | | |
| Recovery | Minimum, % | 97.0% | 97.7% | Yes | D86 |
| | volume | | | | |
| Residue | Maximum, % | 1.5% | 0.9% | Yes | D86 |
| | volume | | | | |
| Loss | Maximum, % | 1.5% | 1.4% | Yes | D86 |
| | volume | | | | |
| Vapor Pressure, | Minimum, | 38.0 | | Yes | D232 or |
| @38° C. | kPa | | | | D5191 |
| | Reported, kPa | | 40.4 | | D232 or |
| | | | | | D5191 |
| | Maximum, | 49.0 | | Yes | D232 or |
| | kPa | | | | D5191 |
| Freezing Point | Maximum, ° C. | −58 | −78 | Yes | D2386 |
| Copper Corrosion | Maximum | 1b | 1a | Yes | D130 |
| Electrical | Maximum, | 450 | 43 | Yes | D2624 |
| Conductivity | pS/m | | | | |
| Potential gum (5 hr) | Maximum, | 6.0 | 1 | Yes | D873 |
| | mg/100 mL | | | | |
| Lead Precipitate | Maximum, | 3.0 | 0.0 | Yes | D873 |
| | mg/100 mL | | | | |
| Water reaction, | Maximum, | 2.0 | 0.0 | Yes | D1094 |
| volume change | mL | | | | |
| Sulfur | Maximum, | 0.05 | 0.00 | Yes | D1266 or |
| | wt % | | | | D2622 |
| Tetraethyl lead (TEL) | Minimum, | 0.27 | | No | D3341 or |
| | mL/L | | | | D5059 |
| | Calculated, | | 0.00 | | D3341 or |
| | mL/L | | | | D5059 |
| | Maximum, | 0.53 | | Yes | D3341 or |
| | mL/L | | | | D5059 |
| Pb (lead) | Minimum, | 0.28 | | No | D3341 or |
| | g/L | | | | D5059 |
| | Reported, g/L | | 0.00 | | D3341 or |
| | | | | | D5059 |
| | Maximum, | 0.56 | | Yes | D3341 or |
| | g/L | | | | D5059 |
| MMT | Minimum, | | | | |
| | μL/L | | | | |
| | Calculated, | | 178 | | |
| | μL/L | | | | |
| | Maximum, | | | | |
| | μL/L | | | | |
| Mn (Manganese) | Minimum, | | | | |
| | mg/L | | | | |
| | Reported, | | 62 | | |
| | mg/L | | | | |
| | Maximum, | | | | |
| | mg/L | | | | |
| Other properties | | | | | |
| Renewable content | wt % | | 6.8% | | |
| Combined aliphatic | wt % | | 2.8% | | |
| ethers and alcohols as | | | | | |
| oxygen | | | | | |
| Combined methanol | wt % | | 1.4% | | |
| and ethanol | | | | | |

Example 17 test results:

TABLE 4

| | | | | Example | |
|---|---|---|---|---|---|
| | Requirement/ | ASTM | Example | 17 Meets | ASTM Test |
| Specification | Unit | D910 Spec | 17 | D910 Spec | Methods |
| Combustion | | | | | |
| Net Heat of | Minimum | 43.5 | 44.0 | Yes | D4529 or |
| Combustion | (MJ/Kg) | | | | D3338 or |
| | | | | | D4809 |
| | | | | | or D240 |
| Octane Rating | | | | | |
| Knock value, lean | | | | | |
| mixture | | | | | |
| Motor Octane Number | Minimum | 99.6 | 102.3 | Yes | D2700 |
| (MON) | | | | | |
| Aviation lean rating | Minimum | 100.00 | 107.2 | Yes | D2700 |
| Knock value, rich | | | | | |
| mixture | | | | | |
| Performance number | Minimum | 130.00 | >138 | Yes | D909 |
| Requirements for all | | | | | D1266 |
| grades | | | | | |
| Density at 15° C. | Kg/m3 | Report | 702.9 | | D3341 or |
| | | | | | D5059 |
| Distillation | | | | | |
| IBP | ° C. | Report | 44 | | D86 |
| T10 | Maximum, ° C. | 75 | 74 | Yes | D86 |
| T40 | Minimum, ° C. | 75 | 93 | Yes | D86 |
| T50 | Maximum, ° C. | 105 | 95 | Yes | D86 |
| T90 | Maximum, ° C. | 135 | 105 | Yes | D86 |
| End Point | Maximum, ° C. | 170 | 174 | No | D86 |
| Sum of T10 and T50 | Minimum, ° C. | 135 | 169 | Yes | D86 |
| Other Properties | | | | | |
| Recovery | Minimum, % | 97.0% | 97.9% | Yes | D86 |
| | volume | | | | |
| Residue | Maximum, % | 1.5% | 0.9% | Yes | D86 |
| | volume | | | | |
| Loss | Maximum, % | 1.5% | 1.2% | Yes | D86 |
| | volume | | | | |
| Vapor Pressure, | Minimum, | 38.0 | | Yes | D232 or |
| @38° C. | kPa | | | | D5191 |
| | Reported, kPa | | 40.7 | | D232 or |
| | | | | | D5191 |
| | Maximum, | 49.0 | | Yes | D232 or |
| | kPa | | | | D5191 |
| Freezing Point | Maximum, ° C. | −58 | −78 | Yes | D2386 |
| Copper Corrosion | Maximum | 1b | 1a | Yes | D130 |
| Electrical | Maximum, | 450 | 25 | Yes | D2624 |
| Conductivity | pS/m | | | | |
| Potential gum (5 hr) | Maximum, | 6.0 | 1 | Yes | D873 |
| | mg/100 mL | | | | |
| Lead Precipitate | Maximum, | 3.0 | 0.0 | Yes | D873 |
| | mg/100 mL | | | | |
| Water reaction, | Maximum, | 2.0 | 0.0 | Yes | D1094 |
| volume change | mL | | | | |
| Sulfur | Maximum, | 0.05 | 0.00 | Yes | D1266 or |
| | wt % | | | | D2622 |
| Tetraethyl lead (TEL) | Minimum, | 0.27 | | No | D3341 or |
| | mL/L | | | | D5059 |
| | Calculated, | | 0.00 | | D3341 or |
| | mL/L | | | | D5059 |
| | Maximum, | 0.53 | | Yes | D3341 or |
| | mL/L | | | | D5059 |
| Pb (lead) | Minimum, | 0.28 | | No | D3341 or |
| | g/L | | | | D5059 |
| | Reported, g/L | | 0.00 | | D3341 or |
| | | | | | D5059 |
| | Maximum, | 0.56 | | Yes | D3341 or |
| | g/L | | | | D5059 |
| MMT | Minimum, | | | | |
| | μL/L | | | | |
| | Calculated, | | 247 | | |
| | μL/L | | | | |
| | Maximum, | | | | |
| | μL/L | | | | |
| Mn (Manganese) | Minimum, | | | | |
| | mg/L | | | | |
| | Reported, | | 86 | | |
| | mg/L | | | | |
| | Maximum, | | | | |
| | mg/L | | | | |
| Other properties | | | | | |
| Renewable content | wt % | | 6.8% | | |
| Combined aliphatic | wt % | | 2.8% | | |
| ethers and alcohols as | | | | | |
| oxygen | | | | | |
| Combined methanol | wt % | | 1.4% | | |
| and ethanol | | | | | |

Comparative Example 1 test results:

TABLE 5

| | Requirement/ | ASTM | Comparative | ASTM Test |
|---|---|---|---|---|
| Specification | Unit | D910 Spec | Example 1 | Methods |
| Combustion | | | | |
| Net Heat of Combustion | Minimum | 43.5 | 44.0 | D4529 or |
| | (MJ/Kg) | | | D3338 or |
| | | | | D4809 |
| | | | | or D240 |
| Octane Rating | | | | |
| Knock value, lean mixture | | | | |
| Motor Octane Number (MON) | Minimum | 99.6 | 102.6 | D2700 |
| Aviation lean rating | Minimum | 100.00 | 108.1 | D2700 |
| Knock value, rich mixture | | | | |
| Performance number | Minimum | 130.00 | 135.0 | D909 |
| Requirements for all grades | | | | D1266 |
| Density at 15° C. | Kg/m3 | Report | 711.4 | D3341 or |
| | | | | D5059 |
| Distillation | | | | |
| IBP | ° C. | Report | 34 | D86 |
| T10 | Maximum, ° C. | 75 | 68 | D86 |
| T40 | Minimum, ° C. | 75 | 99 | D86 |
| T50 | Maximum, ° C. | 105 | 102 | D86 |
| T90 | Maximum, ° C. | 135 | 111 | D86 |
| End Point | Maximum, ° C. | 170 | 139 | D86 |
| Sum of T10 and T50 | Minimum, ° C. | 135 | 188 | D86 |
| Other Properties | | | | |
| Recovery | Minimum, % | 97.0% | 97.5% | D86 |
| | volume | | | |
| Residue | Maximum, % | 1.5% | 1.5% | D86 |
| | volume | | | |
| Loss | Maximum, % | 1.5% | 1.0% | D86 |
| | volume | | | |
| Vapor Pressure, @38° C. | Minimum, | 38.0 | | D232 or |
| | kPa | | | D5191 |
| | Reported, kPa | | 42.7 | D232 or |
| | | | | D5191 |
| | Maximum, | 49.0 | | D232 or |
| | kPa | | | D5191 |
| Freezing Point | Maximum, ° C. | −58 | −82 | D2386 |
| Copper Corrosion | Maximum | 1b | 1b | D130 |
| Electrical Conductivity | Maximum, | 450 | | D2624 |
| | pS/m | | | |
| Potential gum (5 hr) | Maximum, | 6.0 | 0.4 | D873 |
| | mg/100 mL | | | |
| Lead Precipitate | Maximum, | 3.0 | 0.0 | D873 |
| | mg/100 mL | | | |
| Water reaction, volume change | Maximum, | 2.0 | 0.0 | D1094 |
| | mL | | | |
| Sulfur | Maximum, | 0.05 | | D1266 or |
| | wt % | | | D2622 |
| Tetraethyl lead (TEL) | Minimum, | 0.27 | | D3341 or |
| | mL/L | | | D5059 |
| | Calculated, | | 0.47 | D3341 or |
| | mL/L | | | D5059 |
| | Maximum, | 0.53 | | D3341 or |
| | mL/L | | | D5059 |
| Pb (lead) | Minimum, | 0.28 | | D3341 or |
| | g/L | | | D5059 |
| | Reported, g/L | | 0.49 | D3341 or |
| | | | | D5059 |
| | Maximum, | 0.56 | | D3341 or |
| | g/L | | | D5059 |

Comparative Example 2 test results:

TABLE 6

| | Requirement/ | ASTM | Comparative | ASTM Test |
|---|---|---|---|---|
| Specification | Unit | D910 Spec | Example 2 | Methods |
| Combustion | | | | |
| Net Heat of Combustion | Minimum | 43.5 | 44.1 | D4529 or |
| | (MJ/Kg) | | | D3338 or |
| | | | | D4809 |
| | | | | or D240 |
| Octane Rating | | | | |
| Knock value, lean mixture | | | | |
| Motor Octane Number | Minimum | 99.6 | 100.5 | D2700 |
| (MON) | | | | |
| Aviation lean rating | Minimum | 100.00 | 102.4 | D2700 |
| Knock value, rich mixture | | | | |
| Performance number | Minimum | 130.00 | 130.5 | D909 |
| Requirements for all grades | | | | D1266 |
| Density at 15° C. | Kg/m3 | Report | 708.7 | D3341 or |
| | | | | D5059 |
| Distillation | | | | |
| IBP | ° C. | Report | 39 | D86 |
| T10 | Maximum, ° C. | 75 | 72 | D86 |
| T40 | Minimum, ° C. | 75 | 98 | D86 |
| T50 | Maximum, ° C. | 105 | 101 | D86 |
| T90 | Maximum, ° C. | 135 | 109 | D86 |
| End Point | Maximum, ° C. | 170 | 133 | D86 |
| Sum of T10 and T50 | Minimum, ° C. | 135 | 173 | D86 |
| Other Properties | | | | |
| Recovery | Minimum, % | 97.0% | 98.2% | D86 |
| | volume | | | |
| Residue | Maximum, % | 1.5% | 0.9% | D86 |
| | volume | | | |
| Loss | Maximum, % | 1.5% | 0.9% | D86 |
| | volume | | | |
| Vapor Pressure, @38° C. | Minimum, | 38.0 | | D232 or D5191 |
| | kPa | | | |
| | Reported, kPa | | 38.4 | D232 or D5191 |
| | Maximum, | 49.0 | | D232 or D5191 |
| | kPa | | | |
| Freezing Point | Maximum, ° C. | −58 | −70 | D2386 |
| Copper Corrosion | Maximum | 1b | 1b | D130 |
| Electrical Conductivity | Maximum, | 450 | 3 | D2624 |
| | pS/m | | | |
| Potential gum (5 hr) | Maximum, | 6.0 | 3 | D873 |
| | mg/100 mL | | | |
| Lead Precipitate | Maximum, | 3.0 | 0.2 | D873 |
| | mg/100 mL | | | |
| Water reaction, volume | Maximum, | 2.0 | 0.5 | D1094 |
| change | mL | | | |
| Sulfur | Maximum, | 0.05 | 0.00 | D1266 or |
| | wt % | | | D2622 |
| Tetraethyl lead (TEL) | Minimum, | 0.27 | | D3341 or |
| | mL/L | | | D5059 |
| | Calculated, | | 0.44 | D3341 or |
| | mL/L | | | D5059 |
| | Maximum, | 0.53 | | D3341 or |
| | mL/L | | | D5059 |
| Pb (lead) | Minimum, | 0.28 | | D3341 or |
| | g/L | | | D5059 |
| | Reported, g/L | | 0.47 | D3341 or |
| | | | | D5059 |
| | Maximum, | 0.56 | | D3341 or |
| | g/L | | | D5059 |

### Additional Disclosure

The particular embodiments disclosed above are merely illustrative, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and such variations are considered within the scope and spirit of the present disclosure. Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of or “consist of” the various components and steps. Use of the term “optionally” with respect to any element of a claim means that the element is present, or alternatively, the element is not present, both alternatives being within the scope of the claim.

Numbers and ranges disclosed above may vary by some amount. Whenever a numerical range with a lower limit and an upper limit is disclosed, any number and any included range falling within the range is specifically disclosed. In particular, each range of values (of the form, “from about a to about b,” or, equivalently, “from approximately a to b,” or, equivalently, “from approximately a-b”) disclosed herein is to be understood to set forth each number and range encompassed within the broader range of values. Also, the terms in the claims have their plain, ordinary meaning unless otherwise explicitly and unambiguously defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:

A: An aviation gasoline comprising: from about 55 vol % to about 80 vol % isooctane; and from about 20 vol % to about 45 vol % ethyl-tert-butyl-ether, wherein the aviation gasoline has a MON of at least 99.6.

B: An aviation gasoline consisting essentially of: from about 55 vol % to about 65 vol % isooctane; from about 25 vol % to about 35 vol % ethyl-tert-butyl-ether; from about 7 vol % to about 13 vol % methyl-tert-butyl-ether; from about 0.1 vol % to about 2 vol % alcohol; from 0.000 g/gal to about 0.05 g/gal tetraethyl lead; and, optionally, one or more additives selected from the group consisting of: antioxidants, anti-icing agents, antistatic additives, corrosion inhibitors, dyes, lubricants, and mixtures thereof, and wherein the aviation gasoline has a MON of at least 99.6.

C: An aviation gasoline consisting of: from about 55 vol % to about 65 vol % isooctane; from about 25 vol % to about 35 vol % ethyl-tert-butyl-ether; from about 7 vol % to about 13 vol % methyl-tert-butyl-ether; from about 0.1 vol % to about 2 vol % alcohol; from 0.000 g/gal to about 0.05 g/gal tetraethyl lead; and, optionally, one or more additives selected from the group consisting of: antioxidants, anti-icing agents, antistatic additives, corrosion inhibitors, dyes, lubricants, and mixtures thereof, and wherein the aviation gasoline has a MON of at least 99.6.

D: An aviation gasoline comprising: from about 55 to about 56 vol % isooctane; from about 25 to about 35 vol % ethyl-tert-butyl-ether; from about 5 vol % to about 15 vol % methyl-tert-butyl-ether; from about 0.5 vol % to about 5 vol % methanol; from about 0.3 to about 1.5 vol % ethanol; from about 0.3 to about 1.5 vol % tert-butanol; from 0 to about 5 vol % m-toluidine; and from 0 to about 0.4 g/gal manganese naphthenate, wherein the aviation gasoline has a MON of at least 99.6.

E: An aviation gasoline comprising: from about 54 to about 64 vol % isooctane; from about 35 to about 45 vol % of one or more dialkyl ethers; and optionally from about 0.1 to about 2 vol % of one or more alcohols, wherein the aviation gasoline has a MON of at least 99.6.

F: An aviation gasoline comprising: from about 45 vol % to about 80 vol % isooctane; from about 10 vol % to about 45 vol % ethyl-tert-butyl-ether; from about 0 vol % to about 15 vol % methyl-tert-butyl-ether; from about 0 vol % to about 40 vol % of one or more monocyclic aromatic compounds; and from about 0 vol % to about 5 vol % of one or more alcohols, wherein the aviation gasoline has a MON of at least 99.6.

G: An aviation gasoline comprising: from about 70 vol % to about 80 vol % isooctane (2,2,4-trimethylpentane); from about 5 vol % to about 9 vol % isopentane (2-methylbutane); from about 10 vol % to about 20 vol % of one or more dialkyl ether; and from about 1 vol % to about 5 vol % of one or more alcohols, wherein the aviation gasoline has a motor octane number of at least 99.6.

H: An aviation gasoline consisting essentially of: from about 70 vol % to about 80 vol % isooctane (2,2,4-trimethylpentane); from about 5 vol % to about 9 vol % isopentane (2-methylbutane); from about 10 vol % to about 20 vol % of one or more dialkyl ether; from about 1 vol % to about 5 vol % of one or more alcohols; from about 0.02 vol % to about 0.07 vol % of one or more octane enhancer; and optionally, one or more additives selected from the group consisting of: antioxidants, anti-icing agents, anti-static additives, corrosion inhibitors, dyes, lubricants, and mixtures thereof, wherein the aviation gasoline has a motor octane number of at least 99.6.

Each of embodiments A, B, C, D, E, F, G, and H may have one or more of the following additional elements:

Element 1: additionally comprise from about 5 vol % to about 15 vol % methyl-tert-butyl-ether. Element 2: additionally comprise from about 0.1 vol % to about 5 vol % alcohol. Element 3: wherein the alcohol is selected from the group consisting of: methanol and ethanol. Element 4: comprise one or more additives selected from the group consisting of antioxidants, anti-icing agents, antistatic additives, corrosion inhibitors, dyes, lubricants, octane boosters, and mixtures thereof. Element 5: comprise from about 0.001 g/gal to about 0.08 g/gal tetraethyl lead. Element 6: comprise 0.000 g/gal tetraethyl lead. Element 7: be lead-free. Element 8: comprise from about 56 vol % to about 62 vol % isooctane, from about 27 vol % to about 33 vol % ethyl-tert-butyl-ether, from about 7 vol % to about 13 vol % methyl-tert-butyl-ether, and from about 0.5 vol % to about 1.5 vol % alcohol, and wherein the alcohol is methanol. Element 9: comprise from about 56 vol % to about 62 vol % isooctane, from about 27 vol % to about 33 vol % ethyl-tert-butyl-ether, from about 7 vol % to about 13 vol % methyl-tert-butyl-ether, from about 0.5 vol % to about 1.5 vol % alcohol, from about 0.001 g/gal to about 0.08 g/gal tetraethyl lead, and wherein the alcohol is methanol. Element 10: comprise from about 0.1 vol % to about 5 vol % methanol and from about 0.1 vol % to about 1 vol % water. Element 11: consist essentially of about 59 vol % isooctane, about 30 vol % ethyl-tert-butyl-ether, about 10 vol % methyl-tert-butyl-ether, about 1 vol % alcohol, 0.000 g/gal tetraethyl lead, and wherein the alcohol is methanol and the at least one additive is an antioxidant. Element 12: consists essentially of: about 59 vol % isooctane, about 30 vol % ethyl-tert-butyl-ether, about 10 vol % methyl-tert-butyl-ether, about 1 vol % alcohol, about 0.05 g/gal tetraethyl lead and wherein the alcohol is methanol and the at least one additive is an antioxidant. Element 13: additionally comprising at least one octane booster. Element 14: wherein at least one of the at least one octane booster is selected from the group consisting of: toluidine, aniline, N-methylaniline, methylcyclopentadienyl manganese tricarbonyl, and manganese naphthenate. Element 15: wherein the MON is at least 101.5. Element 16: wherein the MON is at least 102.5. Element 17: wherein the octane booster comprises from about 0 vol % to about 5 vol % of the aviation gasoline. Element 18: additionally comprising mesitylene. Element 19: consist essentially of 59 vol % isooctane, 30 vol % ETBE, 10 vol % MTBE, and 1 vol % methanol. Element 20: wherein at least one dialkyl ether is ethyl-tert-butyl-ether. Element 21: wherein a ratio of a first dialkyl ether to a second dialkyl ether is about 3:1. Element 22: wherein the first dialkyl ether is ethyl-tert-butyl-ether and the second dialkyl ether is methyl-tert-butyl-ether. Element 23: wherein the one or more monocyclic aromatic compounds comprise a monocyclic aromatic in the C7-C9 range. Element 24: wherein greater than 90% of the monocyclic aromatic compounds comprise between seven and nine carbon atoms. Element 25: wherein at least one of the monocyclic aromatic compounds is selected from the group consisting of: toluene, m-xylene, o-xylene, p-xylene, mixed xylenes, a trimethylbenzene species, and a dimethylethylbenzene species. Element 26: wherein the one or more alcohols is selected from the group consisting of: methanol, ethanol, iso-propanol, iso-butanol, and tert-butanol. Element 27: additionally comprising up to 0.85 g/gal of a manganese-containing compound. Element 28: wherein the manganese is methylcyclopentadienyl manganese tricarbonyl. Element 29: additionally comprising up to 0.4 oz/gal detergent additive. Element 30: wherein the detergent additive is a polyether amine detergent additive. Element 31: wherein the aviation gasoline comprises: (i) from about 45 vol % to about 65 vol % isooctane; (ii) from about 10 vol % to about 30 vol % ethyl-tert-butyl-ether; from about 15 vol % to about 35 vol % of one or more monocyclic aromatic compounds; and from about 0.2 vol % to about 3 vol % of one or more alcohols, wherein the aviation gasoline has a MON of at least 99.6. Element 32: wherein the aviation gasoline comprises: (i) from about 50 vol % to about 60 vol % isooctane; (ii) from about 15 vol % to about 25 vol % ethyl-tert-butyl-ether; from about 20 vol % to about 35 vol % of one or more monocyclic aromatic compounds; and from about 0.5 vol % to about 4 vol % of one or more alcohols, wherein the aviation gasoline has a MON of at least 99.6. Element 33: wherein the one or more dialkyl ether comprises ethyl tert-butyl ether (2-ethoxy-2-methyl-propane). Element 34: wherein the one or more dialkyl ether is ethyl tert-butyl ether. Element 35: wherein the one or more dialkyl ether comprises ethyl tert-butyl ether and methyl tert-butyl ether (2-methoxy-2-methylpropane). Element 36: wherein the one or more alcohol comprises methanol. Element 37: wherein the one or more alcohol is methanol. Element 38: additionally comprising from about 0.02 vol % to about 0.07 vol % of one or more octane enhancer. Element 39: wherein the octane enhancer is MMT (also known as methylcyclopentadienyl manganese tricarbonyl). Element 40: additionally comprising one or more additives selected from the group consisting of: antioxidants, anti-icing agents, anti-static additives, corrosion inhibitors, dyes, lubricants, and mixtures thereof. Element 41: additionally comprising from about 0.001 g/gal to about 0.08 g/gal tetraethyl lead. Element 42: comprising from about 76 vol % to about 78 vol % isooctane, from about 6 vol % to about 8 vol % isopentane, from about 14 vol % to about 16 vol % of one or more dialkyl ether, from about 0.5 vol % to about 2 vol % of one or more alcohol, and from about 0.02 vol % to about 0.07 vol % of an octane enhancer, wherein the one or more dialkyl ether is ethyl tert-butyl ether, the one or more alcohol is methanol, the octane enhancer is methylcyclopentadienyl manganese tricarbonyl, and the aviation gasoline has a motor octane number of at least 100.5. Element 43: includes a vehicle comprising a fuel tank at least partially filled with the aviation gasoline. Element 44: includes a storage tank at least partially filled with the aviation gasoline. Element 45: consisting essentially of about 76 vol % to about 78 vol % isooctane, from about 6 vol % to about 8 vol % isopentane, from about 14 vol % to about 16 vol % of one or more dialkyl ether, from about 0.5 vol % to about 2 vol % of one or more alcohol, and from about 0.02 vol % to about 0.07 vol % of an octane enhancer, wherein the one or more dialkyl ether is ethyl tert-butyl ether, the one or more alcohol is methanol, the octane enhancer is methylcyclopentadienyl manganese tricarbonyl, and aviation gasoline has a motor octane number of at least 100.5. Element 46: has a MON of at least 101.5. Element 47: has a MON of at least 101.8. Element 48: has a MON of at least 102. Element 49: the aviation gasoline has a MON of 96.0, 96.5, 97.0, 97.5, 98.0, 98.5, 99.0, 99.5, 100.0, 100.5, 101.0, 101.5, 102, or 102.5.

While certain embodiments have been shown and described, modifications thereof can be made by one skilled in the art without departing from the teachings of this disclosure. Numerous other modifications, equivalents, and alternatives, will become apparent to those skilled in the art once the above disclosure is fully appreciated. It is intended that the following claims be interpreted to embrace such modifications, equivalents, and alternatives where applicable.

Accordingly, the scope of protection is not limited by the description set out above but is only limited by the claims which follow, that scope including equivalents of the subject matter of the claims.

What is claimed is:

1. An aviation gasoline comprising:
from about 70 vol % to about 80 vol % alkylate;
from about 5 vol % to about 9 vol % isopentane;
from about 10 vol % to about 20 vol % of one or more dialkyl ether; and
from about 1 vol % to about 5 vol % of one or more alcohol, wherein the aviation gasoline has a motor octane number of at least 96.0.

2. The aviation gasoline according to claim 1 wherein the alkylate is isooctane.

3. The aviation gasoline according to claim 1 the one or more dialkyl ether comprises ethyl tert-butyl ether.

4. The aviation gasoline according to claim 1 wherein the one or more dialkyl ether comprises ethyl tert-butyl ether and methyl tert-butyl ether.

5. The aviation gasoline according to claim 1 wherein the one or more alcohol comprises methanol.

6. The aviation gasoline according to claim 1 wherein the one or more alcohol is methanol.

7. The aviation gasoline according to claim 1 additionally comprising from about 0.02 vol % to about 0.07 vol % of one or more octane enhancer.

8. The aviation gasoline according to claim 7 wherein the octane enhancer is methylcyclopentadienyl manganese tricarbonyl.

9. The aviation gasoline according to claim 1 additionally comprising one or more additives selected from the group consisting of: antioxidants, anti-icing agents, anti-static additives, corrosion inhibitors, dyes, lubricants, and mixtures thereof.

10. The aviation gasoline according to claim 1 additionally comprising from about 0.001 g/gal to about 0.08 g/gal tetraethyl lead.

11. The aviation gasoline according to claim 1 comprising from about 76 vol % to about 78 vol % isooctane, from about 6 vol % to about 8 vol % isopentane, from about 14 vol % to about 16 vol % of one or more dialkyl ether, from about 0.5 vol % to about 2 vol % of one or more alcohol, and from about 0.02 vol % to about 0.07 vol % of an octane enhancer, wherein the one or more dialkyl ether is ethyl tert-butyl ether, the one or more alcohol is methanol, the octane enhancer is methylcyclopentadienyl manganese tricarbonyl, and the aviation gasoline has a motor octane number of at least 100.5.

12. A vehicle comprising a fuel tank at least partially filled with the aviation gasoline according to claim 1.

13. A storage tank at least partially filled with the aviation gasoline according to claim 1.

14. An aviation gasoline consisting essentially of:
from about 70 vol % to about 80 vol % isooctane;
from about 5 vol % to about 9 vol % isopentane;
from about 10 vol % to about 20 vol % of one or more dialkyl ether;
from about 1 vol % to about 5 vol % of one or more alcohol;
from about 0.02 vol % to about 0.07 vol % of one or more octane enhancer; and
optionally, one or more additives selected from the group consisting of: antioxidants, anti-icing agents, anti-static additives, corrosion inhibitors, dyes, lubricants, and mixtures thereof,
wherein the aviation gasoline has a motor octane number of at least 99.6.

15. The aviation gasoline according to claim 14 wherein the one or more dialkyl ether is ethyl tert-butyl ether.

16. The aviation gasoline according to claim 14 wherein the one or more alcohol is methanol.

17. The aviation gasoline according to claim 14 wherein the one or more octane enhancer is methylcyclopentadienyl manganese tricarbonyl.

18. The aviation gasoline according to claim 14 consisting essentially of about 76 vol % to about 78 vol % isooctane, from about 6 vol % to about 8 vol % isopentane, from about 14 vol % to about 16 vol % of one or more dialkyl ether, from about 0.5 vol % to about 2 vol % of one or more alcohol, and from about 0.02 vol % to about 0.07 vol % of an octane enhancer, wherein the one or more dialkyl ether is ethyl tert-butyl ether, the one or more alcohol is methanol, the octane enhancer is methylcyclopentadienyl manganese tricarbonyl, and aviation gasoline has a motor octane number of at least 100.5.

19. A vehicle comprising a fuel tank at least partially filled with the aviation gasoline according to claim 14.

20. A storage tank at least partially filled with the aviation gasoline according to claim 14.
